(19) United States
(12) Patent Application Publication
(10) Pub. No.: US 2008/0073451 A1
(43) Pub. Date: Mar. 27, 2008

(54) Asymmetric nozzle for dispensing a fluid

(76) Inventors: Glenn Allen Bradbury, Mason, OH (US); James Franklin Sloan, Williamsburg, VA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/526,411

(22) Filed: Sep. 25, 2006

(51) Int. Cl. B05B 1/00

(52) U.S. Cl. 239/599; 239/601; 239/598; 239/597

(57) ABSTRACT

A nozzle for spraying a fluid. The nozzle has in asymmetric orifice geometry. This asymmetric geometry provides a non-uniform flow pattern. This arrangement provides a heavier flow in one direction transverse to the primary flow direction of the nozzle and a lighter flow in a different direction transverse to the primary flow direction. The nozzle may be used with a floor cleaning device to provide a particularly desirable spray pattern on a surface to be cleaned.

### FIELD OF THE INVENTION

The present invention relates to spray nozzles and more particularly to spray nozzles having a particular spray pattern.

### BACKGROUND OF THE INVENTION

Nozzles for spraying are well known in the art. Fluids may include liquids, gasses, plasmas, flowable granular materials and combinations thereof. Depending upon the pressure applied to the fluid, the fluid rheology and the nozzle geometry, the fluid may be expelled from the nozzle as a dribble, continuous stream, discrete droplets, etc., all of which are referred to herein as a spray.

A nozzle typically has an orifice which may be thought of as the aperture through which fluid is discharged from the nozzle. The nozzle may also have one or more internal chambers, which contain pressurized fluid prior to its expulsion through the nozzle orifice. The internal chamber(s) may be used to provide swirl, a lateral dispersion, flow rate, mixing with air, etc. The nozzle may incidentally comprise various fittings and other external configurations for convenience of mounting, assembly, etc.

A nozzle may be thought of as having a primary flow direction. The primary flow direction may be thought of as the scalar direction of fluid flow immediately upon exiting the nozzle orifice, without any lateral dispersion, as further defined below. Of course, the nozzle will have a spray pattern, which distributes fluid in various directions having a flow component perpendicular to the primary flow direction. The spray, which occurs off-axis relative to the primary flow direction provides the spray distribution pattern of the nozzle.

The art has attempted to influence the spray pattern through the nozzle geometry. For example, different attempts in the art include attempts to provide a wide lateral spray curtain, a flat fan-shaped spray, the use of multiple orifices, flows with a Mach number greater than one, a two-stage nozzle, the use of deflector plates, adjustable flow rates, etc.

However, these attempts in the art have not addressed the need for nozzles which provided a step change in the fluid distribution, as taken in the primary flow direction. Nor do such attempts in the art attempt to regulate the flow pattern of a horizontally oriented nozzle in the vertical direction.

### SUMMARY OF THE INVENTION

The invention may comprise a nozzle for dispensing a fluid. The nozzle may comprise an inlet and an outlet defining a flow path therebetween. The flow path may have a primary flow direction extending outwardly from said outlet. The nozzle may diverge in the primary flow direction to form an included angle subtending two unequal subangles contiguous about the primary flow direction and which combine to form the included angle. Alternativle, the invention may be thought of as a nozzle having a primary flow direction and diverging in the primary flow direction to form an included angle, wherein the included angle is not bisected by said primary flow direction.

In one execution the invention may comprise a device for cleaning a surface. The device may have a handle and be able to receive a fluid for distribution onto the surface through a nozzle. The nozzle may spray the fluid away from a head usable to contact the surface with a cleaning implement. The nozzle may have an outlet defined by a channel with opposed walls asymmetrically diverging outwardly from a channel entrance towards a channel exit.

All patents cited herein are incorporated herein by reference, but are expressly not admitted to be prior art against the present invention.

### BRIEF DESCRIPTION OF THE DRAWINGS

FIG. 1 is a perspective view of a nozzle according to the present invention.

FIG. 2 is a vertical sectional view taken along lines 2-2 of FIG. 1.

FIG. 3 is a front elevational view of the nozzle of FIG. 1.

### DETAILED DESCRIPTION OF THE INVENTION

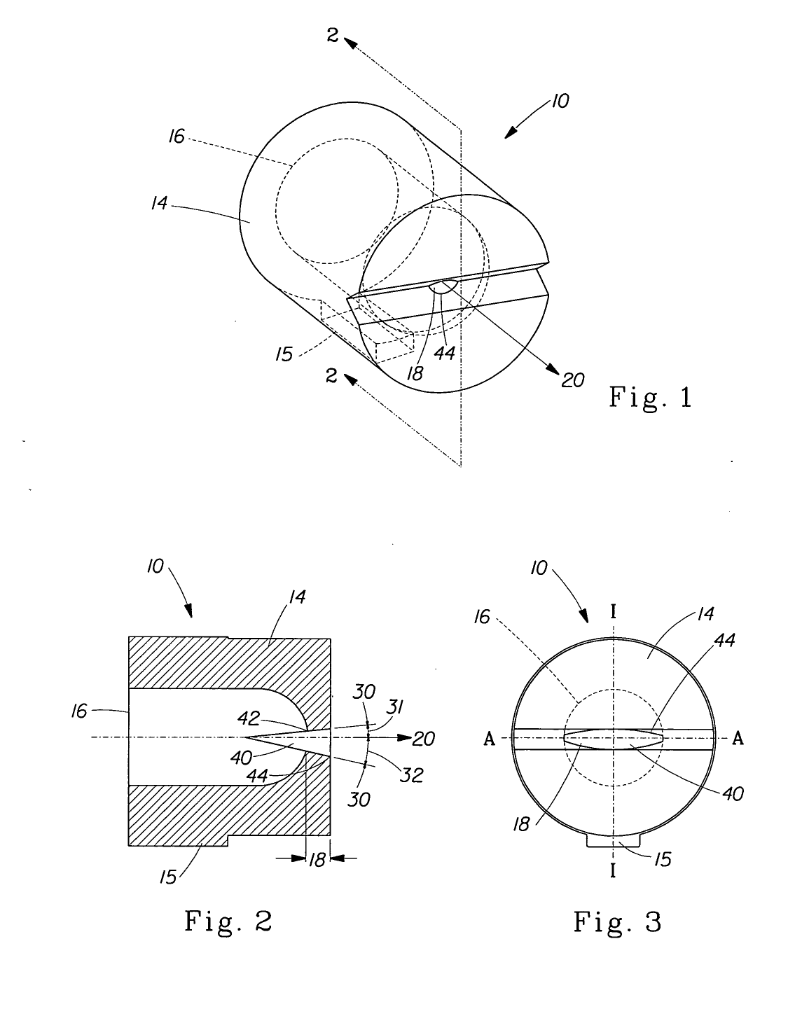

Referring to FIG. 1, the invention comprises a nozzle 10. The nozzle 10 may be usable for flow rates ranging from 0.1 mL/minute or less to 10 mL/minute or more. A single nozzle 10 may be utilized. Or, alternatively, plural nozzles 10 may be utilized together in a bank of nozzles 10. If plural nozzles 10 are selected, they may be identical, similar or mutually different. For example, the plural nozzles 10 may have the same or different flow rates, spray patterns, may spray the same or different fluids, may have different positionings and/or orientations relative to the area desired to be covered by the spray, etc.

The nozzle 10 may have a housing 14. The housing 14 may define and/or hold various components of the nozzle 10 in a fixed or otherwise predetermined relationship. The nozzle 10 may comprise at least one inlet 16 and at least one outlet 18 remote therefrom. Intermediate the inlet 16 and the outlet 18 may be a chamber for containing the fluid in a flow path 20 therebetween.

While nozzles 10 having single and/or plural inlets 16 and single and/or plural outlets 18 are contemplated and within the scope of the invention, the invention will be described hereinbelow as having only a single inlet 16 and outlet 18 for simplicity. However, one of ordinary skill will recognize the invention is not so limited.

The housing 14 may provide a frame for the nozzle 10. The housing 14 may be unitary or comprised of multiple parts. A suitable nozzle 10 may be injection molded and made of plastic or other polymeric materials or of metal. The choice of materials for the nozzle 10 may depend upon the fluid intended to be used therewith, the expected operating environment, the necessity of maintaining sanitary conditions, etc. The housing 14 may contain one or more external features, such as a key 15 suitable for mounting the nozzle 10 in a device usable for spraying or otherwise dispensing the fluid.

Fluid may enter the nozzle 10 through the inlet 16. Fluid may be provided in batch or continuous form from a reservoir or other fluid supply. The fluid may be supplied under pressure from a tank, a pump, provided by gravity feed, etc.

Fluid may flow through the nozzle 10 in a flow path 20 from the inlet 16 to the outlet 18. Fluid may dynamically be disposed in a chamber intermediate the inlet 16 and outlet 18 as the fluid travels through the flow path 20. The chamber may be of generally constant cross-section, or may converge as the nozzle 10 outlet 18 is approached. The convergence may have a linear taper, arcuate taper, a step-wise convergence, be monotonic, nonmontonic, etc.

The chamber may be elongate, as shown. Such a chamber may have a longitudinal axis, which axis may be coincident a primary flow direction. The chamber may have a distal end, remote from the inlet 16 of the nozzle 10. The distal end of the chamber may be generally hemispherically shaped.

The nozzle 10 outlet 18 may comprise the last portion of the flow path 20 of the fluid before ejection from the nozzle 10. The nozzle 10 outlet 18 may comprise an outlet 18 channel 40. The outlet 18 channel 40 may have a channel entrance 42 and a channel exit 44. The outlet 18 channel 40 may diverge from the channel entrance 42 to the channel exit 44.

Such divergence defines an included angle 30. The included angle 30 is comprised of two contiguous subangles 31, 32. Each subangle 31, 32 is defined by two legs. The subangles 31, 32 have a common leg, lying on the primary flow direction. The other leg of the subangles 31, 32 is defined by the wall of the nozzle 10 outlet 18 channel 40. A straight line may be drawn relative to the outlet 18 channel 40 and connecting the channel entrance 42 and channel exit 44. This line defines the other leg of the subangle 31, 32.

Referring to FIG. 2, the nozzle 10 may comprise a primary flow direction. The primary flow direction is a scalar direction, extending outwardly from the outlet 18 of the nozzle 10. The primary flow direction is the particular direction comprising a line which is perpendicular to the plane of the channel entrance 42 and extending outwardly from the center of the channel entrance 42. The primary flow direction may be, but is not necessarily, perpendicular to the channel exit 44 of the nozzle 10.

For simplicity, the primary flow direction is shown in the figures to be coincident the horizontal. However, the invention is not so limited. The primary flow direction may be oriented horizontal, vertical (upwards or downwards), or any direction therebetween. The primary flow direction may also be oriented outwardly from and directly forward of the user, angled to the left or right, oriented behind the user, or any angle therebetween.

Referring to FIG. 3, the nozzle 10 outlet 18 may comprise any suitable shape or cross-section. While a nozzle 10 outlet 18 having a generally rectangular shape is shown, the invention is not so limited. A nozzle 10 outlet 18 having a round shape, square shape, and various irregular shapes which may be symmetric or asymmetric about one or more axes perpendicular to the plane of the outlet 18 are contemplated and within the scope of the present invention.

The nozzle 10 shown in FIG. 3 is asymmetric about a major axis A-A and symmetric about minor axis I-I. The subangles 31, 32 are illustrated, in this non-limiting embodiment, as lying above and below the major axis A-A and having a common vertex lying upon the longitudinal axis of the chamber and/or upon the primary flow direction.

Referring back to FIG. 2, the subangles 31, 32 may be mutually different. For the non-limiting, illustrative embodiments described here, the included angle 30 may range from a narrower included angle 30 of at least about 4, 6, 8, 10 or 12 degrees to a wider included angle 30 of not more than about 120, 90, 60, 30 or 20 degrees, although smaller and larger included angles 30 may be suitable. The subangles 31, 32 may combine to form the included angle 30. The subangles 31, 32 may be proportioned in any suitable ratio, including but not limited to about 70/30, 60/40, 55/45, 52/48, etc. The subangles 31, 32 may have a difference of at least about 1, 2, 3, 4, 5, 10, 15 or more degrees. One non-limiting example may have an included angle 30 of about 14 degrees, comprised of an upper subangle 31 of about 6 degrees and a lower subangle 32 of about 8 degrees, so that the upper subangle 31 is greater than the lower subangle 32.

If the subangles 31, 32 are distributed about a horizontal axis, as shown, the larger subangle 32 may be disposed above the smaller subangle 31, or vice versa. If the subangles 31, 32 are distributed about a vertical axis, the larger subangle 32 may be distributed in the direction desired to receive less spray.

This nonlimiting exemplary geometry provides a spray pattern, particularly suitable for applying a fluid to a horizontal surface. For example, such a spray pattern may be used to spray a cleaning solution onto a floor. Such a spray pattern may be accomplished using a cleaning implement, as discussed below.

Such an exemplary spray pattern may have two discernible zones. A first zone may be located directly in front of the nozzle 10 and comprise a relatively greater density of the fluid, indicating a greater amount of the fluid was sprayed per unit area in the first zone. A second zone may be disposed outward of and beyond the first zone. The second zone may comprise a relatively lesser density of the fluid, indicating a lesser amount of the fluid was sprayed per unit area in the second zone. The second zone may be laterally wider than the first zone.

Taken in the longitudinal direction, the density may change as a step function from the relatively greater density of the first zone to the relatively lesser density of the second zone. The step function may have a relatively steep slope or a more gradual slope. However, the densities between the two zones need not gradually change as an imperceptible gradient from a relatively greater density to a relatively lesser density. Instead, the user may visually discern the two zones of relatively greater and relatively lesser density.

The discernible difference between the two zones may provide the benefit to the user of a visual cue. The visual cue may indicate to the user that the relatively greater density zone immediately in front of the nozzle 10 is present and available for use on the respective surface. For example, the fluid may be utilized for cleaning, applying a protective layer to the surface, disinfecting, changing the appearance of the surface, etc. The relatively lesser density zone may provide a visual cue to the user that an applicator, such as a cleaning cloth, may be utilized to spread and apply fluid from the first zone into the second and fluid from either zone onto the surface. This arrangement may be particularly advantageous for cleaning a relatively large horizontal surface, such as a floor.

The nozzle 10 described hereinabove has been exemplified as having an asymmetric divergence, relative to a single plane. Particularly, the nozzle 10 described hereinabove is illustrated to have a single asymmetrical divergence about a horizontal plane coincident the primary flow direction. However, the invention is not so limited. The nozzle 10 may also have an asymmetric divergence relative to other planes as well. For example, the nozzle 10 may have an asymmetric divergence, relative to the horizontal plane and/or relative to the vertical plane, or relative to any other multiple planes, as desired.

Furthermore, if the nozzle 10 has plural asymmetric divergences, such divergences may or may not be mutually equal. The nozzle 10 may have a greater amount of asymmetry in one plane than in another plane, according to the desired spray pattern and intended use.

The nozzle 10 according to the present invention can be incorporated into the various devices suitable for spraying or otherwise dispensing the fluid through the nozzle 10. Certain devices are suitable for consumer use in the home, while other devices may be for commercial applications, manufacturing etc.

Devices suitable for use in the home to produce sprays and using the claimed nozzle 10 may include, but are not limited to hand-held sprayers. Exemplary hand-held sprayers include trigger sprayers, pumps, pressurized sprayers, pre-compression sprayers, sprayers fueled by propellant, chambers with mechanical sprayers, steamers, steam irons, etc. Such a sprayer may provide a spray pattern with a volume per unit surface area of less than about 0.07 ml/inch2 (0.011 ml/cm2) with a standard deviation in the volume per unit surface area of less than about 0.056 ml/inch2 (0.0087 ml/cm2). Nonlimiting examples of suitable spray dispensers that may provide a suitable spray pattern include the T-8500 and 813N sprayers manufactured by Indesco, Inc. of St. Peters, Mich. and TS-800-2 and TS-800-2E available from Calmar, Inc. An exemplary electric hand-held sprayer is the 460PH sprayer manufactured by Solo Inc., of Newport News, Va.

Another device suitable for use with the nozzle 10 of the claimed invention is a mop-type cleaning implement. Such an implement may have a handle and a mop head attached to the handle. A disposable cleaning cloth may be removably attached to the mop head for contacting the surface to be cleaned. The device may further comprise a reservoir for holding a fluid, such as a liquid cleaning solution, sanitizer, etc. The reservoir may be refillable or, upon depletion, may be removed and replaced with a reservoir having a suitable quantity of fluid therein.

Suitable devices may be made according to the teachings of commonly assigned U.S. Pat. No. 6,669,391 B2 issued Dec. 30, 2003 and U.S. Pat. No. 6,814,519 B2 issued Nov. 9, 2004.

While limited embodiments have been described, all variations and equivalent structures are within the scope of the appended claims.

What is claimed is:

1. A nozzle for dispensing a fluid, said nozzle comprising:
an inlet and an outlet defining a flow path therebetween, said flow path having a primary flow direction extending outwardly from said outlet, said nozzle diverging in the primary flow direction to form an included angle subtending two unequal subangles contiguous about said primary flow direction and which combine to form said included angle.

2. A nozzle for dispensing a fluid, said nozzle comprising:
an inlet and an outlet defining a flow path therebetween, said flow path having a primary flow direction extending outwardly from said outlet, said nozzle diverging in the primary flow direction to form an included angle, wherein said included angle is not bisected by said primary flow direction.

3. A device for cleaning a surface, said device having a handle and being able to receive a fluid for distribution onto the surface through a nozzle, wherein said nozzle sprays the fluid away from a head usable to contact the surface with a cleaning implement, the nozzle having an outlet defined by a channel with opposed walls asymmetrically diverging outwardly from a channel entrance towards a channel exit.

4. A nozzle according to claim 1 wherein said included angle ranges from about 4 to about 120 degrees.

5. A nozzle according to claim 4 wherein said included angle ranges from about 10 to about 30 degrees.

6. A nozzle according to claim 1 wherein said nozzle comprises a chamber in fluid communication with said inlet and said outlet, and providing a flow path therebetween, said chamber having a hemispherical dome for receiving the fluid therein, said outlet intercepting said hemispherical dome.

7. A nozzle according to claim 4 having a greater subangle and a lesser subangle, wherein said greater subangle exceeds said lesser subangle by about 2 to about 4 degrees.

8. A nozzle according to claim 1 wherein outlet of said nozzle as a major axis and a minor axis orthogonal thereto, said major axis and said minor axis being mutually unequal and transverse to said primary flow direction.

9. A nozzle according claim 8 wherein said major axis has a dimension greater than that of said minor axis and is generally horizontally oriented when said nozzle is in use.

10. A nozzle according to claim 2 wherein said orifice outlet comprises a channel entrance and a channel exit in fluid comunication therewith and having substantially straight walls therebetween.

11. A nozzle according to claim 2 having orifice walls extending substantially from said inlet to said outlet, said walls being curvilinear.

12. A device according to claim 3 wherein the fluid can be sprayed upon demand.

13. A device according to claim 12 wherein the fluid is sprayed in a dual zone pattern, said pattern comprising a heavier spray density closer to said outlet of said nozzle and a lighter spray density forward of said heavier spray density wherein said heavier and lighter spray densities are distinguishable by a step function.

14. A device according to claim 12 wherein cleaning implement further comprises a removable cloth.

15. A device according to claim 14 comprising an elongate handle and being suitable for cleaning a floor from a standing position.
